(19) United States
(12) Patent Application Publication
(10) Pub. No.: US 2026/0039500 A1
(43) Pub. Date: Feb. 5, 2026

(54) COOKING APPARATUS AND METHOD FOR CONTROLLING THE SAME

(71) Applicant: SAMSUNG ELECTRONICS CO., LTD., Suwon-si (KR)

(72) Inventors: Juneok AHN, Suwon-si (KR); Jaewoong KIM, Suwon-si (KR); Seokjung YOON, Suwon-si (KR); Sanga KIM, Suwon-si (KR); Minkyung AHN, Suwon-si (KR); Yunkyeong LEE, Suwon-si (KR); Useong JANG, Suwon-si (KR)

(73) Assignee: SAMSUNG ELECTRONICS CO., LTD., Suwon-si (KR)

(21) Appl. No.: 19/269,771

(22) Filed: Jul. 15, 2025

Related U.S. Application Data
(63) Continuation of application No. PCT/KR2025/009292, filed on Jul. 1, 2025.

(30) Foreign Application Priority Data
Aug. 2, 2024 (KR) 10-2024-0103431

(51) Int. Cl. H04L 12/28; F24C 7/08; F24C 14/00; G06T 7/00

(52) U.S. Cl. CPC H04L 12/281; F24C 7/08; F24C 14/00; G06T 7/97; H04L 2012/285

(57) ABSTRACT

A cooking apparatus includes: a cooking chamber configured to accommodate an object to be cooked; a camera; and a controller configured to cause the cooking apparatus to: obtain, by the camera, a plurality of images of an inside of the cooking chamber based on the object being accommodated in the cooking chamber and in a cooking process, compare the plurality of images to identify image change for each region, assign a contamination weight to the each region based on the image change, and perform a cleaning process based on completion of the cooking process and the contamination weight, wherein each image of the plurality of images includes a plurality of regions.

### CROSS-REFERENCE TO RELATED APPLICATIONS

This application is a continuation of International Application No. PCT/KR2025/009292, filed Jul. 1, 2025, and claims foreign priority to Korean Application No. 10-2024-0103431, filed Aug. 2, 2024, and which are incorporated herein by reference in their entireties.

### TECHNICAL FIELD

The disclosure relates to a cooking apparatus and a method for controlling the same.

### BACKGROUND ART

In general, a cooking apparatus is an appliance that includes a cooking chamber, a heating device for heating the cooking chamber, and a circulation fan to circulate heat generated by the heating device in the cooking chamber, to cook food.

The cooking apparatus is an appliance that cooks by sealing and heating an object to be cooked, and is generally classified into electric, gas, or electronic cooking apparatus depending on a heat source. An electric oven uses a heater as a heat source, a gas oven uses heat from gas, and a microwave oven uses frictional heat of water molecules caused by high frequency as a heat source.

In general, the cooking apparatus includes a main body forming an external appearance and having a cooking chamber into which an object to be cooked is inserted through a front opening. In addition, the cooking apparatus includes a door installed on the front of the main body to selectively open and close the cooking chamber, and a control panel provided on the front of the main body to allow a user to set a desired cooking course or various conditions required for cooking.

Users often wonder when to clean the cooking chamber. In a case where high temperature cleaning is performed frequently, the cooking apparatus may be damaged due to extreme heat. However, in a case where the cooking apparatus has not been cleaned for a long time, grease stains may adhere so firmly that the stains cannot be removed even by steam cleaning.

Accordingly, the inside of the cooking chamber requires to be kept clean by performing an optimal cleaning process at an appropriate time based on an actual contamination level of the inside of the cooking chamber.

### DISCLOSURE

### Technical Problem

The disclosure provides a cooking apparatus and a method for controlling the same that may clean a cooking chamber by an optimal cleaning process at an appropriate time by assigning and accumulating a contamination weight based on a contaminated location and a contamination level identified from changes in images of an inside of the cooking chamber.

Technical aspects that can be achieved by the disclosure are not limited to the above-mentioned aspects, and other technical aspects not mentioned will be clearly understood by one of ordinary skill in the technical art to which the disclosure belongs from the following description.

### Technical Solution

According to an embodiment of the disclosure, a cooking apparatus may include a cooking chamber configured to accommodate an object to be cooked; a camera; and a controller configured to cause the cooking apparatus to: obtain, by the camera, a plurality of images of an inside of the cooking chamber based on the object being accommodated in the cooking chamber and in a cooking process, compare the plurality of images to identify image change for each region, assign a contamination weight to the each region based on the image change, and perform a cleaning process based on completion of the cooking process and the contamination weight, wherein each image of the plurality of images includes a plurality of regions.

According to an embodiment of the disclosure, a method may be provided for controlling a cooking apparatus includes a cooking chamber configured to accommodate an object to be cooked, and a camera, the method comprising: obtaining, by the camera, a plurality of images of an inside of a cooking chamber based on the object being accommodated in the cooking chamber and in a cooking process; comparing the plurality of images to identify image change for each region; assigning a contamination weight to the each region based on the image change; and performing a cleaning process based on completion of the cooking process and the contamination weight, wherein, each image of the plurality of images includes a plurality of regions.

### DESCRIPTION OF DRAWINGS

FIG. 1 is a perspective view of an example of a cooking apparatus according to an embodiment.

FIG. 2 is a front view of an example of a cooking apparatus according to an embodiment.

FIG. 3 is a control block diagram of an example of a cooking apparatus according to an embodiment.

FIG. 4 is a flowchart illustrating an example of a method for controlling a cooking apparatus according to an embodiment.

FIG. 5 illustrates a plurality of images of an inside of a cooking chamber obtained by a camera during a cooking process in a cooking apparatus according to an embodiment.

FIG. 6 illustrates identifying an image change region in a cooking apparatus according to an embodiment.

FIG. 7 illustrates determining whether an image change region is a food region or a non-food region, in a cooking apparatus according to an embodiment.

FIG. 8 illustrates assigning different contamination weights for a food region and a non-food region of an image change region, in a cooking apparatus according to an embodiment.

FIG. 9 illustrates assigning a contamination weight for each location of an image change region in a case where a location of the image change region corresponds to a food region, in a cooking apparatus according to an embodiment.

FIG. 10 illustrates accumulated contamination weights of image change regions, in a cooking apparatus according to an embodiment.

FIG. 11 illustrates correction of a range of contamination weights assigned to an image change region depending on a cooking type, in a cooking apparatus according to an embodiment.

FIG. 12 is a flowchart illustrating an example of performing a cleaning process by additionally taking into account the number of times and a time of a cooking process, in a cooking apparatus according to an embodiment.

FIG. 13 is a flowchart illustrating another example of a method for controlling a cooking apparatus according to an embodiment.

FIG. 14 is a flowchart illustrating an example of performing a cleaning process, in a cooking apparatus according to an embodiment.

### MODES OF THE DISCLOSURE

Various embodiments and the terms used therein are not intended to limit the technology disclosed herein to specific forms, and the disclosure should be understood to include various modifications, equivalents, and/or alternatives to the corresponding embodiments.

In describing the drawings, similar reference numerals may be used to designate similar constituent elements.

A singular expression may include a plural expression unless otherwise indicated herein or clearly contradicted by context.

In the disclosure, phrases, such as “A or B”, “at least one of A and B”, “at least one of A or B”, “A, B or C”, “at least one of A, B and C”, and “at least one of A, B, or C” may include any one or all possible combinations of the items listed together in the corresponding phrase among the phrases.

The term of “and/or” includes a plurality of combinations of relevant items or any one item among a plurality of relevant items. For example, “A and/or B” may include only “A”, only “B”, or both “A and B”.

In this disclosure, the terms “including”, “having”, and the like are used to specify features, numbers, steps, operations, elements, components, or combinations thereof, but do not preclude the presence or addition of one or more of the features, elements, steps, operations, elements, components, or combinations thereof.

When an element is said to be “connected”, “coupled”, “supported” or “contacted” with another element, this includes not only when elements are directly connected, coupled, supported or contacted, but also when elements are indirectly connected, coupled, supported or contacted through a third element.

Throughout the description, when an element is “on” another element, this includes not only when the element is in contact with the other element, but also when there is another element between the two elements.

Meanwhile, the terms “front”, “rear”, “left”, “right”, “upper”, and “lower” used in the following description are defined based on the drawings, and the shape and location of each component are not limited by these terms. For example, the front side may be defined as the +X side and the rear side may be defined as the −X side. For example, based on the drawings, the right side may be defined as the +Y side and the left side may be defined as the −Y side. For example, based on the drawings, the upper side may be defined as the +Z side and the lower side may be defined as the −Z side.

Terms such as “1st”, “2nd”, “primary”, or “secondary” may be used simply to distinguish an element from other elements, without limiting the element in other aspects.

In addition, terms such as “unit”, “part”, “block”, “member”, and “module” indicate a unit for processing at least one function or operation. For example, those terms may refer to at least one process processed by at least one hardware such as Field Programmable Gate Array (FPGA), Application Specific Integrated Circuit (ASIC), at least one software stored in a memory or a processor.

Reference will now be made in detail to the exemplary embodiments, examples of which are illustrated in the accompanying drawings, wherein like reference numerals refer to like elements throughout.

Hereinafter, an operating principle and embodiments of the disclosure are described in detail with reference to the accompanying drawings.

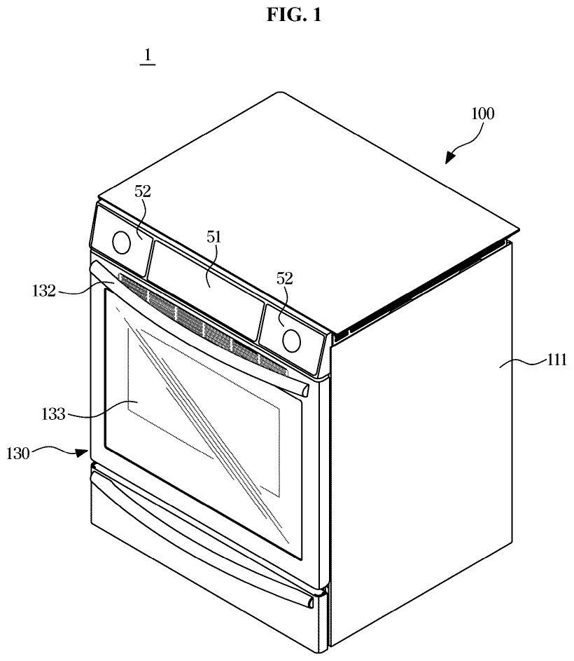

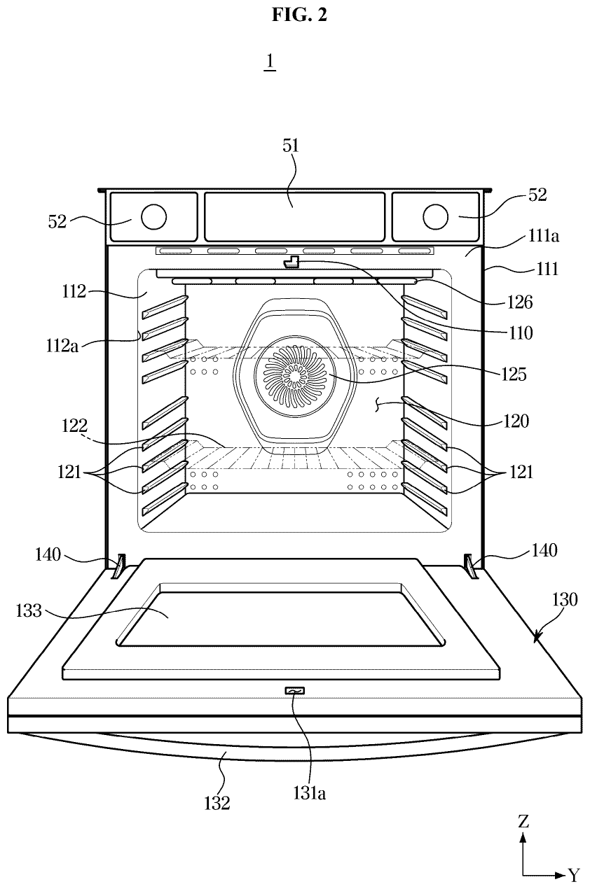

FIG. 1 is a perspective view of an example of a cooking apparatus according to an embodiment. FIG. 2 is a front view of an example of a cooking apparatus according to an embodiment.

A cooking apparatus 1 according to an embodiment of the disclosure may include a cooktop, an oven such as a gas oven or an electric oven, a microwave heating device (hereinafter referred to as a microwave), a gas stove, an electric stove, an over the range (OTR), a gas grill, or an electric grill that uses electricity or gas to heat a cooking container containing food.

The cooking apparatus 1 may include a main body 100. The main body 100 may form an exterior of the cooking apparatus 1.

In the disclosure, the main body 100 may form a cooking chamber 120 accommodating an object to be cooked (hereinafter also referred to as “food”) of the cooking apparatus 1.

The cooking apparatus 1 may include at least one input device 52 and a display 51.

For example, the main body 100 may be provided with at least one input device 52 and the display 51.

In an embodiment, the at least one input device 52 may include a power button.

The power button may be a button for turning on or off the cooking apparatus 1 or various components of the cooking apparatus 1.

For example, the power button may be a button for turning on and/or off the display 51. Examples of the at least one input device 52 are not limited thereto, and any component capable of converting sensory information received from a user into an electrical signal may be used as the at least one input device 52.

In a case where the display 51 is implemented as a touch display, the display 51 may also be an example of the at least one input device.

The display 51 may include, for example, a liquid crystal display (LCD) panel, an indicator, a light emitting diode (LED) panel.

In an embodiment, the display 51 may be implemented as a touch pad, a touch screen, and the like, to receive user input.

The display 51 may display various screens for interaction between a user and the cooking apparatus 1.

The cooking apparatus 1 may include an inner case 112 in which the cooking chamber 120 is formed. The inner case 112 may be provided inside an outer case 111 of the main body 100 described below. Specifically, the inner case 112 may be disposed inside the outer case 111 and may be coupled to the outer case 111.

The cooking chamber 120 may be formed to have an open front to allow food to be taken in and out. The inner case 112 may include a front opening 112a formed to be open so that food may be taken in and out of the cooking chamber 120. A side of the main body 100 in which the front opening 112a is formed is defined as the front of the main body 100.

For example, the inner case 112 may be formed to have a box shape with an approximately open front.

Inner walls of the inner case 112 may be coated to prevent corrosion of the inner walls of the inner case 112 due to condensate that may occur during a condensation process of water vapor or moisture contained in the food itself. The inner walls of the inner case 112 may be dried by heat generated during a cooking process.

A tray 122 on which food or a cooking container containing the food may be placed, and a rack 121 supporting the tray 122 may be provided inside the cooking chamber 120. For example, the tray 122 may be provided to be detachable from the rack 121. For example, the racks 121 may be provided on the left inner wall or the right inner wall of the inner case 112.

The cooking apparatus 1 may include a heater 126 to provide heat to the inside of the cooking chamber 120. For example, the heater 126 may include a gas burner to generate heat by burning gaseous fuel. However, the type of components included in the cooking apparatus 1 to heat food inside the cooking chamber 120 is not limited thereto, and the cooking apparatus 1 may include a magnetron that emits electromagnetic waves into the cooking chamber 120 to generate heat by the rotation of water molecules inside the food, a lighting device that emits light into the cooking chamber 120 to heat the inside of the food, a steam generator that supplies steam into the inside of the cooking chamber 120, and the like.

The cooking apparatus 1 may include a convection fan 125 to circulate air inside the cooking chamber 120. The convection fan 125 may receive rotational force from a fan motor and rotate to circulate air inside the cooking chamber 120. As the air in the cooking chamber 120 is circulated by the convection fan 125, the heat generated by the heater 126 may be evenly transferred inside the cooking chamber 120. For example, the convection fan 125 may be disposed at the rear side of the cooking chamber 120, but its location is not limited thereto.

The cooking apparatus 1 may include the outer case 111. Various components of the cooking apparatus 1 may be accommodated in the outer case 111. The outer case 111 may be arranged to surround an upper side, a lower side, a rear side, a left side, a right side, etc. of the inner case 112.

An insulation (not shown) may be provided between the inner case 112 and the outer case 111 to prevent heat in the cooking chamber 120 from being discharged to the outside of the main body 100. For example, the insulation may include a material such as glass fiber or asbestos.

The outer case 111 may include a front frame 111a. The front frame 111a may be provided at the front of the main body 100. The front frame 111a may form at least a part of the front of the main body 100. When the door 130 closes the cooking chamber 120, the front frame 111a may be covered by the door 130.

The front frame 111a may be formed in the shape of a frame having an opening. The front frame 111a may be formed in the shape of a frame surrounding the front opening 112a.

For example, the inner case 112 may be coupled to the front frame 111a. A portion of the front side of the inner case 112 may be coupled to the front frame 111a.

The outer case 111 may include a rear panel disposed at the rear of the cooking apparatus 1. The rear panel may form at least a portion of the rear exterior of the cooking apparatus 1. Various components such as a gas supply pipe, a printed circuit board, the heater 126, and the convection fan 125 may be mounted on the rear panel.

In addition, the outer case 111 may include a left panel forming the left side of the cooking apparatus 1, a right panel forming the right side of the cooking apparatus 1, a base forming the bottom of the cooking apparatus 1, etc.

The cooking apparatus 1 may include an electronic equipment chamber provided inside the main body 100 and in which various components are arranged. The electronic equipment chamber may be separated from the cooking chamber 120. The electronic equipment chamber may be formed inside the outer case 111. The electronic equipment chamber may be formed outside the inner case 112. For example, the electronic equipment chamber may accommodate components such as a printed circuit board on which electronic components for controlling the operation of various components of the cooking apparatus 1 are mounted, a cooling fan module, and a lever device.

The door 130 may include a handle 132 provided for a user to grasp to open and close the door 130. In order for the user to easily open and close the door 130, the handle 132 may be positioned adjacent to a portion of the door 130 opposite to a rotation axis of the door 130. It is illustrated in FIG. 1 that the handle 132 is provided on the front side of the door 130 as an embodiment, but the disclosure is not limited thereto. The handle 132 may be provided at various locations on the door 130. The ‘front side of the door 130’ described above may refer to a side of the door 130 in the X direction when the door 130 closes the cooking chamber 120.

The door 130 may include a transparent portion 133 formed to be transparent to allow the user to see the inside of the cooking chamber 120, even when the door 130 closes the cooking chamber 120. The transparent portion 133 may include various transparent materials such as glass. For example, the transparent portion 133 may include a plurality of glass plates that are spaced apart from each other and forming an insulating space therebetween so as to prevent heat in the cooking chamber 120 from being transferred to the outside of the door 130 through the transparent portion 133.

The cooking apparatus 1 may include a hinge 140 connecting the main body 100 and the door 130. The hinge 140 may rotatably support the door 130. The hinge 140 may be coupled to each of the main body 100 and the door 130. The door 130 may be coupled to the main body 100 by the hinge 140.

For example, the hinge 140 may be mounted on a lower part of the main body 100.

For example, the hinge 140 may include a pair of hinges 140.

The cooking apparatus 1 may include a latch 110. The latch 110 may be provided to support the door 130 or not to support the door 130. Specifically, the latch 110 may support the door 130 to prevent the door 130 from being opened in a state where the cooking chamber 120 is closed by the door 130, or may release the support of the door 130 to allow the door 130 to be opened. The expression “the latch 110 releases the support of the door 130” refers to a state in which the latch 110 is separated from the door 130 and does not support the door 130 closing the cooking chamber 120.

The cooking apparatus 1 may include a door hole 131a formed to allow a portion of the latch 110 to be inserted.

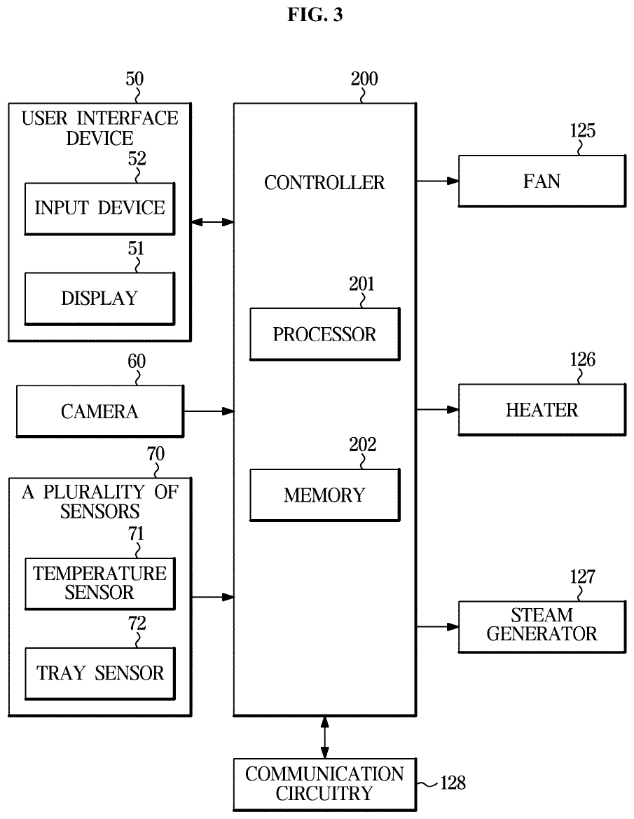

FIG. 3 is a control block diagram of an example of a cooking apparatus according to an embodiment.

Referring to FIG. 3, the cooking apparatus 1 may include a user interface device 50, a camera 60, the fan 125, the heater 126, a steam generator 127, communication circuitry 128, and/or a controller 200. The controller 200 is electrically connected to components of the cooking apparatus 1 and may control components of the cooking apparatus 1.

The user interface device 50 may allow interaction between a user and the cooking apparatus 1.

The user interface device 50 may include the display 51 and the input device 52.

The input device 52 may receive a user input.

The input device 52 may include a start/select button, a dial, a stop/cancel button, an auto-cook button, a clean button, and/or a dial.

The start/select button may receive a command to select a setting selected by the dial, and/or a command to start cooking.

The stop/cancel button may receive a command to cancel a setting selected by the dial, and/or a command to stop cooking.

The auto-cook button may receive a command to input information about an object to be cooked, i.e., information about food. In a case where the user is not sure about the recipe for the food, the auto-cook button may be used to input information about the food the user desires to cook.

The clean button may receive a command to clean the inside of the cooking chamber 120.

In various embodiments, the input device 52 may include the communication circuitry 128 in that a user input may be received from an external device (e.g., a smartphone, a server) via the communication circuitry 128.

Each button and/or dial may include a visual indicator (e.g., a phrase, an icon, etc.) that may indicate its function.

Here, terms such as button, dial, etc. may be replaced with input devices in terms of receiving user input. In addition, input devices such as buttons, dial, etc. may be replaced with various types of input devices.

For example, buttons or dials may be replaced with user interface (UI) elements, tact switches, push switches, slide switches, toggle switches, micro switches, touch switches, touch pads, touch screens, jog dials, and/or microphones.

The input device 52 may include, for example, tact switches, push switches, slide switches, toggle switches, micro switches, touch switches, touch pads, touch screens, jog dials, and/or microphones.

The display 51 may generate sensory information and transmit various information related to the operation of the cooking apparatus 1 to the user.

For example, the display 51 may transmit information related to an operation time of the cooking apparatus 1, settings of the cooking apparatus 1, etc. to the user. Information about an operation of the cooking apparatus 1 may be output via the display, an indicator, a voice, etc. The display 51 may include, for example, a liquid crystal display (LCD) panel, an indicator, a light emitting diode (LED) panel, a speaker, etc.

The display 51 may display information about the operation of the cooking apparatus 1. The display 51 may display information input by the user or information provided to the user on various screens.

The user interface device 50 may receive user input for selecting a cooking process and/or a cleaning process.

The controller 200 may control the operation of the cooking apparatus 1 by processing a command received through the input device 52.

The camera 60 may be installed on the upper portion or on the side of the cooking chamber 120. Specifically, the camera 60 may be installed on the ceiling or side wall of the inner case 112.

The camera 60 may obtain an image of the inside of the cooking chamber 120. For example, in a case where the camera 60 is mounted on the ceiling of the cooking chamber 120, an image obtained by the camera 60 may include images of the four walls (upper, lower, left, and right walls) of the cooking chamber 120 and an image of the lower side on which the food is placed.

The camera 60 may transmit the images of the inside of the cooking chamber 120 to the controller 200. The controller 200 may identify a contamination level of each location inside the cooking chamber 120 based on the images of the inside of the cooking chamber 120 obtained by the camera 60. In addition, the controller 200 may identify information about the food based on an image of the food among the images of the inside of the cooking chamber 120.

The camera 60 may collect information about the food placed in the cooking chamber 120.

The camera 60 may measure a degree of browning of the food in the cooking chamber 120. For example, the camera 60 may collect information related to the degree of browning of the food.

The camera 60 may transmit information related to the degree of browning of the food to the controller 200. The information related to the degree of browning of the food may include image information, color information, steam information, etc. of the cooking chamber 120 in which the food is placed.

Measuring the degree of browning of the food by the camera 60 may include measuring the degree of browning of the food directly by the camera 60, transmitting information related to the degree of browning of the food by the camera 60 to the controller 200, and identifying the degree of browning of the food by the controller 200 based on the information related to the degree of browning of the food.

For example, the controller 200 may identify information about the degree of browning of the food included in the image obtained by the camera 60 using a trained model and/or a lookup table.

The use of the trained model by the controller 200 may include using a trained model stored in the cooking apparatus 1 and/or using a trained model stored in an external device (e.g., a server) via the communication circuitry 128.

The trained model includes an artificial intelligence (Al) model. The trained model may be created by machine learning and/or deep learning. The trained model may be created by a server and may be stored in a memory 202 of the cooking apparatus 1. A learning algorithm may include, for example, supervised learning, unsupervised learning, semi-supervised learning, or reinforcement learning, but is not limited thereto.

The trained model may include a plurality of artificial neural network layers. The artificial neural network may include deep neural network (DNN), convolutional neural network (CNN), recurrent neural network (RNN), Restricted Boltzmann Machine (RBM), deep belief network (DBN), bidirectional recurrent deep neural network (BRDNN), and/or deep Q-networks, but is not limited thereto. Additionally or alternatively, the Al model may include a software structure in addition to the hardware structure.

According to various embodiments, the controller 200 may obtain information about the food included in the image obtained by the camera 60 using the trained model. The information about the food may include the type of the food, the size of the food, the weight of the food, and/or the recipe of the food.

A plurality of sensors 70 may collect information related to the cooking apparatus 1.

The plurality of sensors 70 may include a temperature sensor 71 for measuring a temperature of the cooking chamber 120.

The temperature sensor 71 may be installed at various locations inside the main body 100. The temperature sensor 71 may transmit an electrical signal corresponding to a detected temperature to the controller 200. The controller 200 may control at least one of the heater 126 or the fan 125 based on the temperature of the cooking chamber 120 measured by the temperature sensor 71.

The plurality of sensors 70 may include a tray sensor 72 for detecting the tray 122.

The tray sensor 72 may collect information related to whether the tray 122 is mounted.

The tray sensor 72 may detect whether the tray 122 is mounted on the rack 221 for placing the tray 122. The tray sensor 72 may detect the tray 122 in various ways. For example, the tray sensor 72 may be implemented as a capacitance sensor, a weight sensor, an optical sensor, an ultrasonic sensor, an infrared sensor, and the like.

In addition, the plurality of sensors may include various sensors. For example, the cooking apparatus 1 may include a current sensor and a voltage sensor. The current sensor may measure a current applied to the electronic components of the cooking apparatus 1. The voltage sensor may measure a voltage applied to the electronic components of the cooking apparatus 1.

According to various embodiments, the plurality of sensors 70 may not include some of the sensors described above.

The fan 125 may circulate the air in the cooking chamber 120.

The fan 125 may be referred to as the convection fan 125 in that the fan 125 transfers the air heated by the heater 126 to the food through a convection phenomenon. As the air in the cooking chamber 120 is circulated by the convection fan 125, the heat generated by the heater 126 may be evenly transferred inside the cooking chamber 120.

The controller 200 may control the operation of the fan 125.

For example, the controller 200 may turn the fan 125 on. The controller 200 may turn the fan 125 off.

Turning the fan 125 on may include changing the fan 125 from an off state to an on state.

Turning the fan 125 off may include changing the fan 125 from an on state to an off state.

According to various embodiments, the controller 200 may adjust a rotation speed and a rotation time of the fan 125 according to a type, number, and size of the food, a cooking course, and/or a cleaning process.

The heater 126 may heat the air of the cooking chamber 120.

The heater 126 may include a lightwave heater and/or an electric heater.

The controller 200 may control an operation of the heater 126.

For example, the controller 200 may turn on the heater 126. The controller 200 may turn off the heater 126. The controller 200 may turn on/off the heater 126.

Turning the heater 126 on may include changing the heater 126 from an off state to an on state.

Turning the heater 126 off may include changing the heater 126 to an off state from an on state or changing the heater 126 under on/off control to an off state.

Controlling the on/off of the heater 126 may include repeatedly controlling on/off of the heater 126 to perform a predetermined function (e.g., maintaining a temperature of the cooking chamber 120).

According to various embodiments, the controller 200 may adjust a heating level and a heating time of the heater 126 according to a type, number, and size of the food, a cooking course, and/or a cleaning process.

The steam generator 127 may supply steam to the inside of the cooking chamber 120.

The steam generator 127 may heat water stored in a water tank to generate steam.

The controller 200 may control an operation of the steam generator 127.

For example, the controller 200 may turn on the steam generator 127. The controller 200 may turn off the steam generator 127. The controller 200 may control on/off of the steam generator 127.

Turning the steam generator 127 on may include changing the steam generator 127 from an off state to an on state.

Turning the steam generator 127 off may include changing the steam generator 127 to an off state from an on state or changing the steam generator 127 under on/off control to an off state.

According to various embodiments, the controller 200 may adjust a steam temperature, a steam time, and/or steam amount of the steam generator 127 according to a type, number, and size of the food, a cooking course, and/or a cleaning process.

The communication circuitry 128 may communicate with an external device (e.g., a server, a user device, and/or home appliances) by wire and/or wirelessly.

The communication circuitry 128 may include at least one of a short-range wireless communication module or a long-range wireless communication module.

The communication circuitry 128 may transmit data to an external device or receive data from an external device. For example, the communication circuitry 128 may establish communication with a server, a user device, and/or other home appliances, and transmit and receive various types of data.

For the communication, the communication circuitry 128 may establish a direct (e.g., wired) or wireless communication channels between external devices, and support the performance of communication via the established channel. According to an embodiment, the communication circuitry 128 may include a wireless communication module (e.g., a cellular communication module, a short-range wireless communication module, or a global navigation satellite system (GNSS) communication module) or a wired communication module (e.g., a local area network (LAN) communication module or a power line communication module). Among these communication modules, the corresponding communication module may communicate with an external device through a first network (e.g., a short-range communication network such as Bluetooth, Wi-Fi direct, or infrared data association (IrDA)) or a second network (e.g., a legacy cellular network, a 5G network, a next-generation communication network, the Internet, or a computer network such as a LAN or WAN). These various types of communication modules may be integrated into a single component (e.g., a single chip) or implemented as a plurality of separate components (e.g., multiple chips).

The short-range wireless communication module may include a Bluetooth communication module, a Bluetooth Low Energy (BLE) communication module, a near field communication module, a WLAN (Wi-Fi) communication module, and a Zigbee communication module, an IrDA communication module, a Wi-Fi Direct (WFD) communication module, an ultrawideband (UWB) communication module, an Ant+communication module, a microwave (uWave) communication module, etc., but is not limited thereto.

The long-range wireless communication module may include a communication module that performs various types of long-range wireless communication, and may include mobile communication circuitry. The mobile communication circuitry may transmit and receive radio signals with at least one of a base station, an external terminal, or a server in a mobile communication network.

In an embodiment, the communication circuitry 128 may communicate with an external device such as a server, a user device, and other home appliances through a nearby access point (AP). The access point (AP) may connect a local area network (LAN) to which the cooking apparatus 1, other home appliances, and/or a user device are connected to a wide area network (WAN) to which the server is connected. The cooking apparatus 1, other home appliances, and/or a user device may be connected to the server through the wide area network (WAN).

The controller 200 may receive recipe information from an external device through the communication circuitry 128. The controller 200 may receive a command to control the cooking apparatus 1 from an external device through the communication circuitry 128. The controller 200 may receive information about food from an external device through the communication circuitry 128.

The controller 200 may include a processor 201 and the memory 202. The processor 201 may be hardware and include logic circuits and operation circuits. The processor 201 may control the electrically connected components of the cooking apparatus 1 based on a program, instructions and/or data stored in the memory 202 for operation of the cooking apparatus 1. The controller 200 may be implemented with a control circuit including circuit elements such as a condenser, an inductor and a resistor. The processor 201 and the memory 202 may be implemented in separate chips or in a single chip. In addition, the controller 200 may include a plurality of processors and a plurality of memories.

The memory 202 may store the programs, applications and/or data for the operation of the cooking apparatus 1 and store data generated by the processor 201. The memory 202 may include a non-volatile memory such as a read only memory (ROM) and a flash memory for long-term data storage. The memory 202 may include a volatile memory for temporarily storing data, such as a static random access memory (S-RAM) and a dynamic random access memory (D-RAM).

In an embodiment, the controller 200 may control various components of the cooking apparatus 1 according to various cooking courses.

The controller 200 may compare a plurality of images obtained by the camera 60 during the cooking process to identify an image change region, may assign a contamination weight to the image change region based on a location of the image change region, and may perform a first cleaning process or a second cleaning process based on the contamination weight assigned to the image change region in response to the completion of cooking process.

The components of the cooking apparatus 1 are not limited to those described above. In addition to the components described above, the cooking apparatus 1 may further include various components, and some of the components described above may be omitted.

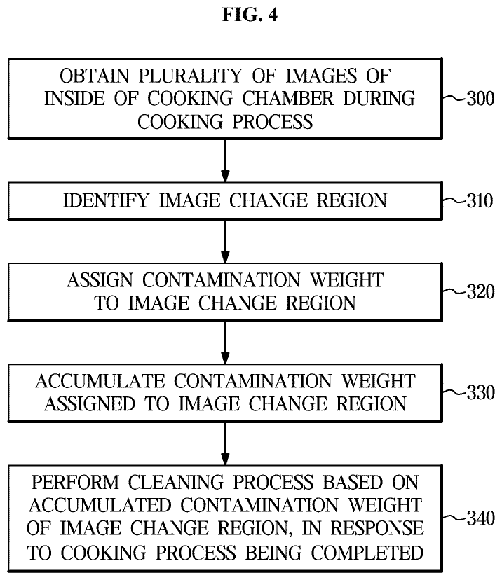

FIG. 4 is a flowchart illustrating an example of a method for controlling a cooking apparatus according to an embodiment.

Referring to FIG. 4, the controller 200 may obtain a plurality of images of the inside of the cooking chamber 120 in which food is placed through the camera 60 while a cooking process is in progress (300).

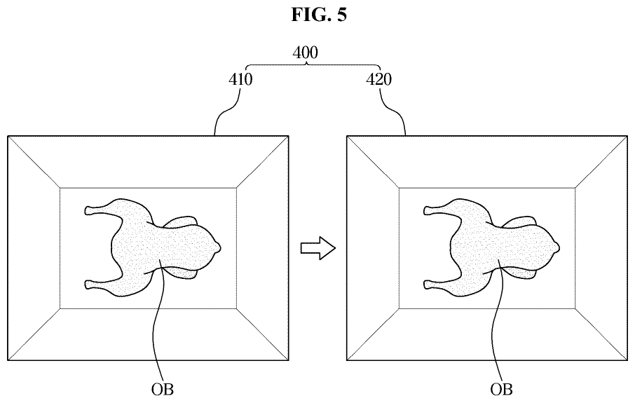

FIG. 5 illustrates a plurality of images of an inside of a cooking chamber obtained by a camera during a cooking process in a cooking apparatus according to an embodiment.

Referring to FIG. 5, through the camera 60 installed inside the cooking chamber 120, images of the inside of the cooking chamber 120 may be obtained periodically or when a specific event occurs.

The camera 60 may be installed in a position where the camera 60 may capture each wall of the cooking chamber 120. For example, the camera 60 may be installed on the ceiling of the cooking chamber 120. The images obtained by the camera 60 mounted on the ceiling may include images of four walls (upper, lower, left, and right walls) of the cooking chamber 120 and a lower side image including the food OB.

The camera 60 may obtain continuous images of the inside of the during the cooking process.

A plurality of images 400 and 410 obtained by the camera 60 may include images of continuous frames.

The plurality of images 400 may include an image of a previous frame (previous image, 410) and an image of a current frame (current image, 420).

The camera 60 may transmit the plurality of images 400 of the inside of the cooking chamber 120 to the controller 200.

The controller 200 may receive and obtain the plurality of images 400 of the inside of the cooking chamber 120 transmitted by the camera 60.

Referring again to FIG. 4, the controller 200 may identify an image change region 510 by comparing the plurality of obtained images 400 (310).

The controller 200 may identify an image change region corresponding to a location where the image has changed by comparing the previous image 410 and the current image 420 while the cooking process is in progress.

A color or shape of the food may change while the food is being cooked. In addition, substances such as sauce that flows or splashes from the food may stick to the wall inside the cooking chamber 120. By comparing the previous image 410 and the current image 420 during the cooking process, the image change region where the food and the wall have changed may be identified.

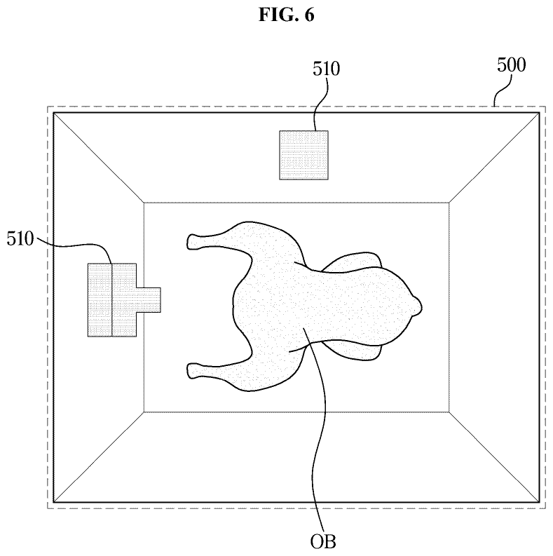

FIG. 6 illustrates identifying an image change region in a cooking apparatus according to an embodiment.

Referring to FIG. 6, the controller 200 may identify the image change region 510 corresponding to a location where the image has changed in an entire image region 500 by comparing the previous image 410 and the current image 420 while the cooking process is in progress.

The controller 200 may identify the image change region 510 in the entire image region 500 based on a difference in pixel information of the same region in the previous image 410 and the current image 420.

More specifically, the controller 200 may perform a preprocessing process to improve the quality of the images before analyzing the obtained images. The controller 200 may perform noise removal, lighting correction, distortion correction, and the like, through the preprocessing process.

The controller 200 may compare the previous image 410 and the current image 420 on a pixel basis after the image preprocessing. In this process, the controller 200 may detect a change by calculating a difference in color value and a difference in brightness value of each pixel.

The controller 200 may generate a difference image that represents the difference between the previous image 410 and the current image 420. A portion of the difference image having a significantly different pixel value may be a region where the image is highly likely to have changed.

The controller 200 may detect pixels that changed more than a threshold value in the difference image to identify the image change region 510. A binary thresholding technique may be used during the process.

In a case where pixels where the changes are detected are adjacent to each other, the controller 200 may treat the adjacent pixels as a block, and consider the block as a single image change region 510.

The controller 200 may identify the image change region 510 from the entire image region 500. The controller 200 may identify information about location changes, size changes, color changes, and pixel changes of the image change region 510.

In various embodiments, the controller 200 may apply a deep learning-based image classification and object recognition technique to increase the identification accuracy of the image change region 510. The controller 200 may train a trained model. The controller 200 may train the trained model to allow the previous image 410 and the current image 420 to be input into the trained model and a difference image between the two images to be output. For example, a convolutional neural network (CNN) may be used as an artificial neural network to train the trained model. The controller 200 may input the previous image 410 and the current image 420 into the trained model while the cooking process is in progress. In response to the input of the previous image 410 and the current image 420, the trained model may generate and output the difference image between the two images. The controller 200 may identify the image change region 510 from the difference image. As such, the image change region 510 may be more accurately identified using the trained model.

Referring again to FIG. 4, the controller 200 may assign a contamination weight to each region based on the image change in the entire image region 500. The controller 200 may identify whether a region having the image change is a food region or a non-food region. The controller (200) may assign a greater contamination weight to the region identified as the non-food region than to the region identified as the food region. Additionally, the controller 200 may assign the contamination weight to the each region based on a changing value in pixel corresponding to the each region. Additionally, the controller 200 may assign the contamination weight for the region identified as the food region based on a distance between the region identified as the food region and a center of the object to be cooked.

For example, the controller 200 may assign a contamination weight to the image change region 510 based on the location of the image change region 510 (320).

The controller 200 may determine whether the location of the image change region 510 is a food region where the food is placed or a non-food region where the food region is excluded.

The controller 200 may assign different contamination weights depending on whether the image change region 510 is a food region or a non-food region.

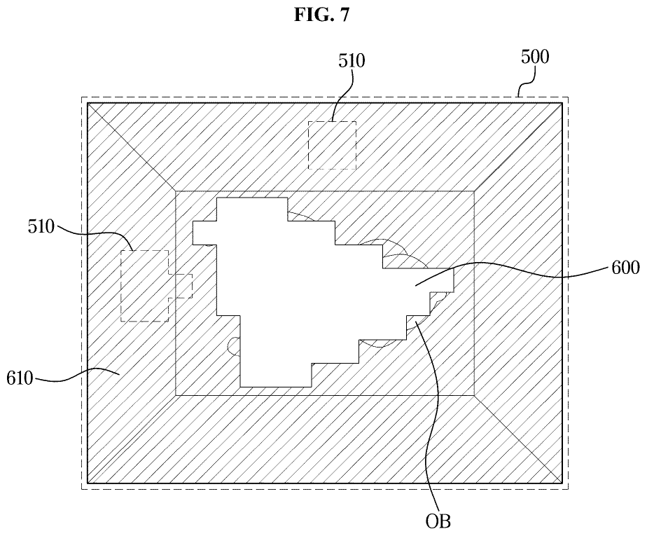

FIG. 7 illustrates determining whether an image change region is a food region or a non-food region, in a cooking apparatus according to an embodiment.

Referring to FIG. 7, the controller 200 may determine whether the location of the image change region 510 is a food region 600 or a non-food region 610.

The food region 600 may include a region where the food OB is located.

The food region 600 may include a region including a part or all of the food OB.

The food region 600 may include a region including a cooking container in which the food OB is stored.

The food region 600 may be a region including only the food OB. The food region 600 may be a region partitioned along an outer line of the food OB. The non-food region 610 may be a region excluding the food region 600 from the entire image region 500.

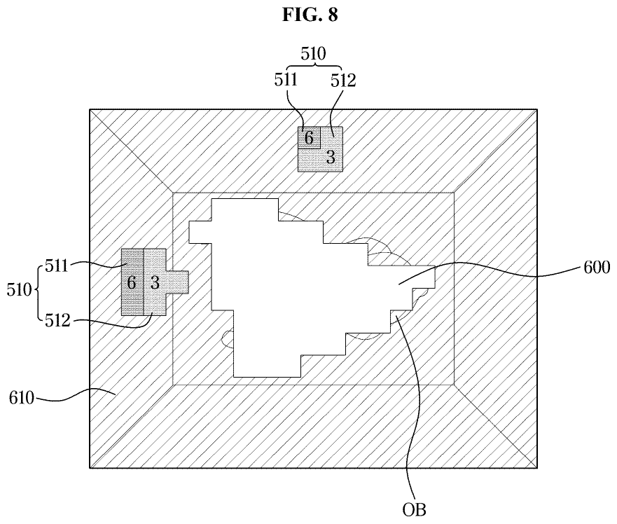

FIG. 8 illustrates assigning different contamination weights for a food region and a non-food region of the image change region, in a cooking apparatus according to an embodiment.

Referring to FIG. 8, in a case where the image change region 510 corresponds to the food region 600, the controller 200 may assign a first contamination weight to the image change region 510.

In a case where the image change region 510 corresponds to the non-food region 610, the controller 200 may assign a second contamination weight to the image change region 510.

The second contamination weight may have a higher value than the first contamination weight. That is, because the change in the food OB is not directly related to contamination, the food region 600 may be assigned the lower contamination weight than the contamination weight of the non-food region 610. In addition, no contamination weight or a contamination weight of “0” may be assigned to the food region 600.

As such, when the image change region 510 corresponds to the non-food region 610, the controller 200 may assign a greater contamination weight than when the image change region 510 corresponds to the food region 600.

Meanwhile, when the location of the image change region 510 corresponds to the non-food region 610, the controller 200 may increase the contamination weight as the amount of change in pixel values of the image change region 510 increases. In other words, a greater contamination weight may be assigned when a contamination level is high than when the contamination level is low.

For example, contamination other than black may be assigned a relatively low contamination weight because such contamination is caused by food and sauce. New black contamination may be assigned a relatively high contamination weight because such contamination is caused by the sauce sticking to the inside of the cooking apparatus at a high temperature. In a case where new black contamination additionally occurs in the current image 420 in addition to the black contamination that existed in the previous image 410, a greater contamination weight may be assigned because such contamination is an additional contamination that occurred in addition to the existing contamination.

In a case where the image change region 510 corresponds to the non-food region 610, the controller 200 may assign a basic contamination weight and then assign an additional contamination weight according to the amount of change in pixel values of the image change region 510.

For example, it is assumed that a first image change region 511 and a second image change region 512 are located in the non-food region 610, and the amount of change in pixels of the first image change region 511 is greater than that of the second image change region 512.

Because the first image change region 511 is located in the non-food region 610, the basic contamination weight of “2” may be assigned, and an additional contamination weight of “4” may be additionally assigned based on the amount of change in pixel values of the first image change region 511. Accordingly, a total contamination weight of “6” may be assigned to the first image change region 511. In this instance, the larger the pixel change amount, the greater the additional contamination weight may be assigned.

Because the second image change region 512 also belongs to the non-food region 610, the basic contamination weight of “2” may be assigned, and an additional contamination weight of “1” may be additionally assigned based on the amount of change in pixel values of the second image change region 512. Accordingly, a total contamination weight of “3” may be assigned to the second image change region 510. For reference, the contamination weight of “0” may be assigned to a region with no image change.

The above-described contamination weight assignment to the image change region 510 may be repeatedly performed by comparing the previous image 410 and the current image 420 while the cooking process is in progress, and the assigned contamination weight may be accumulated in each image change region 510 of the corresponding location.

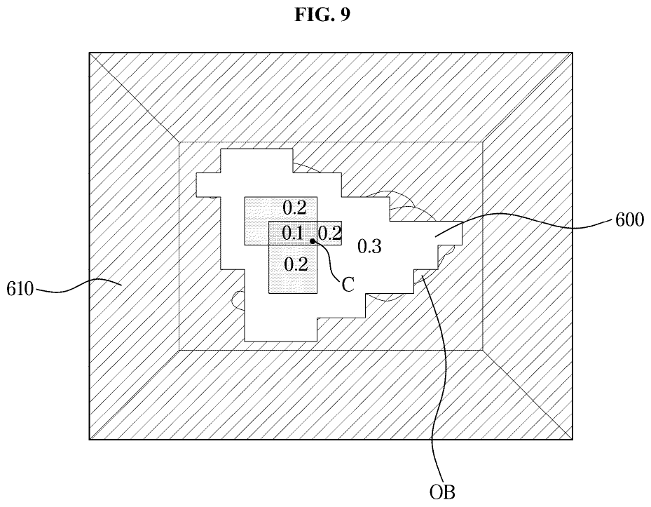

FIG. 9 illustrates assigning a contamination weight for each location of an image change region in a case where a location of the image change region corresponds to a food region, in a cooking apparatus according to an embodiment.

Referring to FIG. 9, in a case where the location of the image change region 510 corresponds to the food region 600, the controller 200 may decrease a contamination weight as the image change region 510 is closer to the center C of the food OB.

In a case where the image change region 510 is located in the food region 600, the controller 200 may assign a lower contamination weight to the image change region 510 as the image change region 510 is closer to the center C from the outside of the food OB.

For example, in a case where the location of the image change region 510 is outside the food OB, a contamination weight of “0.3” may be assigned to the image change region 510. The lower contamination weights in the order of “0.2” and “0.1” may be assigned to the image change region 510, as the image change region 510 is closer to the center C from the outside of the food OB.

Meanwhile, when the food OB is removed from the cooking chamber 120 after a cooking process is completed, the controller 200 may assign a contamination weight to a region covered by the food OB.

More specifically, when the food OB is removed by a user after the cooking process is completed, the controller 200 may compare the current image where the food OB is removed with the image obtained before the cooking process started for the region covered by the food OB, and assign a greater contamination weight to a region with a large amount of change in pixel values.

Referring again to FIG. 4, the controller 200 may accumulate at least one contamination weight on each of at least one region among the plurality of regions for the each region.

For example, the controller 200 may accumulate the contamination weight assigned to the image change region 510 while the cooking process is in progress (330).

The contamination weights assigned to the same image change region 510 during the cooking process may be accumulated.

In the case where a plurality of image change regions 510 exist, the contamination weights assigned to each of the plurality of image change regions 510 may be accumulated for each image change region.

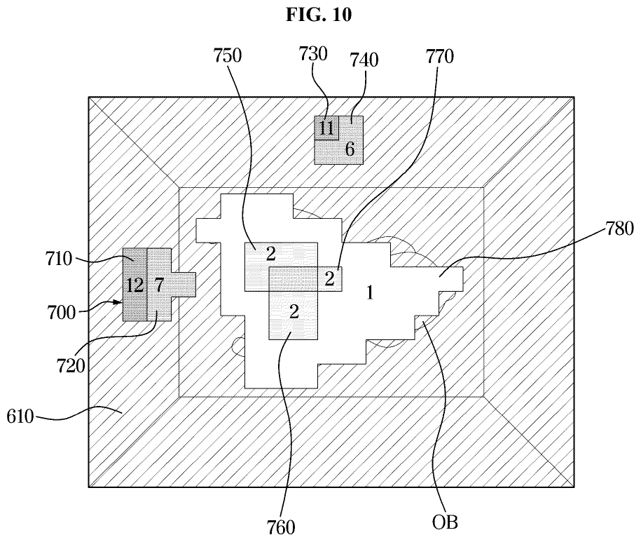

FIG. 10 illustrates accumulated contamination weights of image change regions, in a cooking apparatus according to an embodiment.

Referring to FIG. 10, an example of accumulated contamination weight of a plurality of image change regions while a cooking process is in progress is shown.

The accumulated contamination weight of a first image change region 710 in an entire image change region 700 may be “12”.

The accumulated contamination weight of a second image change region 720 may be “7”.

The accumulated contamination weight of a third image change region 730 may be “11”.

The accumulated contamination weight of a fourth image change region 740 may be “6”.

The first image change region 710 to the fourth image change region 740 may be regions located in the non-food region 610.

For example, an image change region with an accumulated contamination weight of “10” or higher may be determined to be a highly contaminated region. The first image change region 710 with the accumulated contamination weight of “12” and the third image change region 730 with the accumulated contamination weight of “11” may correspond to the highly contaminated region. The first image change region 710 and the third image change region 730 may be contaminated regions where contaminants have been burned at high temperatures and become black during the cooking process for the same region, or where black contaminants have been continuously added to and adhered to the existing black contaminants.

The accumulated contamination weight of a fifth image change region 750 may be “2”.

The accumulated contamination weight of a sixth image change region 760 may be “2”.

The accumulated contamination weight of a seventh image change region 770 may be “2”.

The accumulated contamination weight of an eighth image change region 780 may be “1”.

The fifth image change region 750 to the eighth image change region 780 may be regions located in the food region 600.

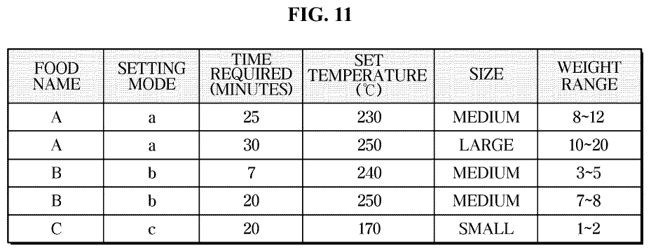

FIG. 11 illustrates correction of a range of contamination weights assigned to an image change region depending on a cooking type, in a cooking apparatus according to an embodiment.

Referring to FIG. 11, the controller 200 may correct an accumulated contamination weight of a corresponding image change region.

In a case where cooking information about a food OB is input or selected by a user through the user interface device 50, the controller 200 may correct the accumulated contamination weight of the image change region 510.

The controller 200 may correct the accumulated contamination weight of the corresponding image change region using a contamination weight correction table corresponding to the cooking information.

The controller 200 may determine whether the accumulated contamination weight of the corresponding image change region is within a probable contamination weight range on the correction table, using the contamination weight correction table corresponding to the cooking information used in the current cooking process, and may correct the accumulated contamination weight within the probable contamination weight range.

As shown in FIG. 11, in a case where a food name is A, a setting mode is a, a required time is 25 minutes, a setting temperature is 230° C., and a size of the food is “medium,” it is assumed that the probable accumulated contamination weight range is “8” to “12.”

In a case where the accumulated contamination weight of the corresponding image change region is “14”, the accumulated contamination weight is outside the probable accumulated contamination weight range of “8” to “12”, and thus the accumulated contamination weight of the corresponding image change region may be corrected from “14” to a value within “8” to “12”.

Similarly, in a case where a food name is B, a setting mode is b, a required time is 7 minutes, a setting temperature is 240° C., and a size of the food is “medium,” it is assumed that the probable accumulated contamination weight range is “3” to “5.”

In a case where the accumulated contamination weight of the corresponding image change region is “6,” the accumulated contamination weight is outside the probable accumulated contamination weight range of “3” to “5,” and thus the accumulated contamination weight of the corresponding image change region may be corrected from “6” to a value within “3” to “5.”

Referring back to FIG. 4, in response to the cooking process being completed, the controller 200 may perform a first cleaning process or a second cleaning process based on the accumulated contamination weight of the image change region 510 (340).

The first cleaning process may be a hot air cleaning process to drive the heater 126 supplying heat to the inside of the cooking chamber 120.

The second cleaning process may be a steam cleaning process to drive the steam generator 127 supplying steam to the inside of the cooking chamber 120.

When the cooking process is completed, the controller 200 may identify a plurality of contaminated regions where an accumulated contamination weight of the corresponding image change region is greater than or equal to a predetermined weight in the plurality of image change regions. For example, an image change region whose accumulated contamination weight is greater than or equal to “10”, indicating a highly contaminated region, may be identified as a contaminated region.

The controller 200 may sum the accumulated contamination weights of the plurality of contaminated regions. For example, the accumulated contamination weights of the image change regions whose accumulated contamination weight is “10” or higher may all be added up.

In a case where the summed contamination weight is greater than or equal to a preset first value, the controller 200 may determine the cleaning process as the hot air cleaning process. Referring to FIG. 10, the accumulated contamination weights of the first image change region 710 and the third image change region 730 having the accumulated contamination weight of “10” or more are added up. The summed contamination weight is 23 (12+11). For example, in a case where the summed contamination weight of 23 is greater than 20, which is a preset first value, it may be determined that the hot air cleaning process is required.

The controller 200 may perform the hot air cleaning process as the cleaning process. In this instance, the controller 200 may perform the hot air cleaning process in response to the number of times the cooking process is performed being greater than or equal to a preset number of times and a cooking time of the cooking process being greater than or equal to a preset time.

Meanwhile, the controller 200 may sum the accumulated contamination weights of all of the plurality of image change regions and may perform a steam cleaning process based on the summed contamination weight being greater than or equal to a preset second value. Referring to FIG. 10, all accumulated contamination weights of the entire image change region 700 are summed. The summed contamination weight is 43 (12+7+11+6+2+2+2+1). For example, in a case where the summed contamination weight of 43 is greater than or equal to the preset second value of 30, it may be determined that the steam cleaning process is required.

Although the condition for the steam cleaning process is satisfied, in a case where the condition for performing the hot air cleaning process is satisfied, the controller 200 may perform the hot air cleaning process prior to the steam cleaning process.

That is, the controller 200 may identify a plurality of contaminated regions where the accumulated contamination weight of the corresponding image change region is greater than or equal to a predetermined weight in the plurality of image change regions, may obtain a first value by summing the accumulated contamination weights of the plurality of contaminated regions, and may obtain a second value by summing the accumulated contamination weights of all of the plurality of image change regions. In this instance, the controller 200 may perform the hot air cleaning process based on the first value being greater than or equal to the preset first value, and may perform the steam cleaning process based on the second value being greater than or equal to the preset second value. However, although the second value is greater than or equal to the preset second value, in a case where the first value is greater than or equal to the preset first value, the hot air cleaning process may be performed.

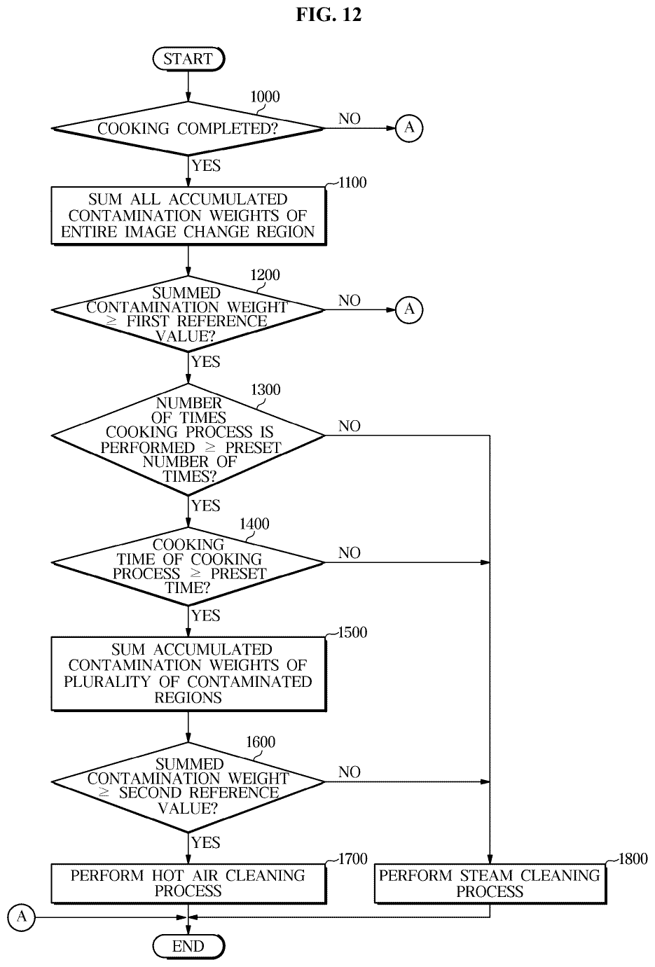

FIG. 12 is a flowchart illustrating an example of performing a cleaning process by additionally taking into account the number of times and a time of a cooking process, in a cooking apparatus according to an embodiment.

Referring to FIG. 12, the controller 200 may sum at least one contamination weight on each of at least one region among the plurality of regions for the each region, or sum contamination weights on regions included in the at least one region. For example, in response to the cooking process being completed (1000), the controller 200 may sum all accumulated contamination weights of the entire image change region 700 (1100).

The controller 200 may determine whether the summed contamination weight is greater than or equal to a first reference value. The first reference value may be a reference value used to determine whether a steam cleaning is required in the cooking chamber 120. Based on the summed contamination weight being greater than or equal to the first reference value (Yes in operation 1200), the controller 200 may determine whether the number of times the cooking process is performed is greater than or equal to a preset number of times (1300).

Based on the number of times the cooking process is performed being greater than or equal to the preset number of times (Yes in operation 1300), the controller 200 may determine whether a cooking time of the cooking process is greater than or equal to a preset time (1400). In a case where the cooking time of the cooking process is longer than the preset time (Yes in operation 1400), the controller 200 may sum the accumulated contamination weights of a plurality of contaminated regions (1500). The plurality of contaminated regions may be image change regions whose accumulated contamination weight are greater than or equal to a predetermined weight in the entire image change regions (700). For example, referring to FIG. 10, the plurality of contaminated regions may be image change regions 710 and 730 where the accumulated contamination weights are greater than or equal to “10” indicating the areas of severe contamination.

The controller 200 may determine whether the summed contamination weight of the accumulated contamination weights of the plurality of contaminated regions is greater than or equal to a second reference value (1600). The second reference value may be a reference value used to determine whether the hot air cleaning is required in the cooking chamber 120.

The controller 200 may perform the hot air cleaning process (1700), based on the summed contamination weight being greater than or equal to the second reference value (Yes in operation 1600).

Meanwhile, the controller 200 may perform the steam cleaning process (1800), in a case where the number of times the cooking process is performed is less than the preset number of times (No in operation 1300), the cooking time of the cooking process is less than the preset time (No in operation 1400), or the summed contamination weight of the plurality of contaminated regions is less than the second reference value (No in operation 1600).

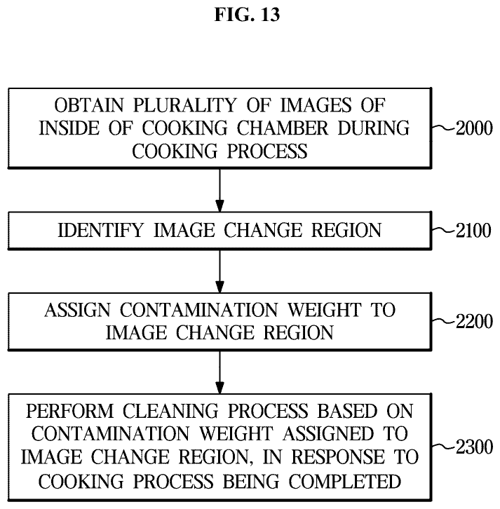

FIG. 13 is a flowchart illustrating another example of a method for controlling a cooking apparatus according to an embodiment.

Referring to FIG. 13, the controller 200 may obtain a plurality of images of the inside of the cooking chamber 120 in which the food is placed through the camera 60 during a cooking process (2000).

The controller 200 may obtain the previous image 410 and the current image 420, which are continuous images of the inside of the cooking chamber 120 while the cooking process is in progress, through the camera 60.

The controller 200 may compare the previous image 410 and the current image 420 while the cooking process is in progress, and identify the image change region 510 corresponding to a location where the image has changed in the entire image region 500 (2100).

The controller 200 may assign a contamination weight to the image change region 510 based on the location, color, and/or pixel information of the image change region 510 (2200).

For example, the controller 200 may determine whether the location of the image change region 510 is a food region or a non-food region, and in a case where the image change region 510 corresponds to the non-food region 610, the image change region 510 may be assigned a greater contamination weight than in a case where the image change region 510 corresponds to the food region 600. In addition, in a case where the location of the image change region 510 corresponds to the non-food region 610, the controller 200 may assign a greater contamination weight as the amount of change in pixel values of the image change region 510 increases. In other words, a greater contamination weight may be assigned when a contamination level is high than when the contamination level is low.

In response to the cooking process being completed, the controller 200 may perform a first cleaning process or a second cleaning process based on the contamination weight assigned to the image change region 510 (2300).

The first cleaning process may be a hot air cleaning process to drive the heater 126 supplying heat to the inside of the cooking chamber 120. The second cleaning process may be a steam cleaning process to drive the steam generator 127 supplying steam to the inside of the cooking chamber 120.

The controller 200 may perform the hot air cleaning process based on the contamination weight assigned to the image change region 510 being greater than or equal to a first weight for performing the hot air cleaning process. In this instance, the hot air cleaning process may be performed in a case where there is no food inside the cooking chamber 120.

The controller 200 may perform the steam cleaning process based on the contamination weight assigned to the image change region 510 being greater than or equal to a second weight for performing the steam cleaning process and less than the first weight. In this instance, the steam cleaning process may be performed in a case where there is no food inside the cooking chamber 120.

In a case where the image change region 510 whose contamination weight is greater than or equal to the first weight exists in the plurality of image change regions 510, the controller 200 may determine that the hot air cleaning process is required regardless of the contamination weights assigned to the other image change regions 510. That is, in a case where a contamination level of a specific image change region is significantly high, it may be determined that the hot air cleaning process is required without having to assign a contamination weight to the other image change regions. In this instance, the contamination weight assigned to the corresponding image change region 510 may be a value that has accumulated the contamination weight more than twice while the cooking process is in progress, or may be a contamination weight assigned once. Although the contamination weight assigned once to the corresponding image change region 510 is greater than or equal to the first weight, it may be determined that the hot air cleaning process is required.

Meanwhile, even in a case where the image change region 510 whose contamination weight assigned once or whose contamination weight accumulated twice or more is less than the first weight exists in a plurality of image change regions 510, the controller 200 may sum the contamination weights assigned once or contamination weights accumulated twice or more to the image change regions adjacent to the corresponding image change region 510, and may determine whether the hot air cleaning process or the steam cleaning process is required based on the summed contamination weight.

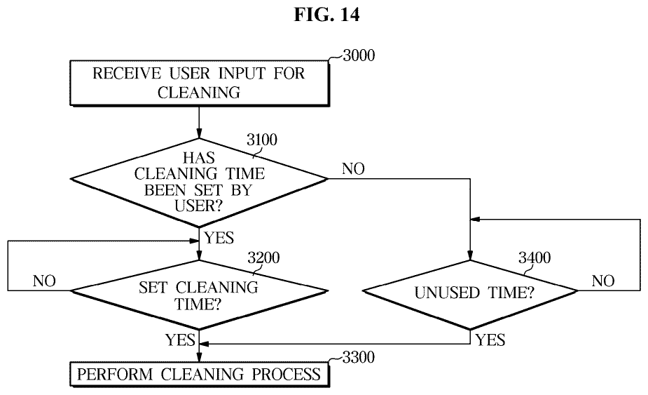

FIG. 14 is a flowchart illustrating an example of performing a cleaning process, in a cooking apparatus according to an embodiment.

Referring to FIG. 14, in a case where a user input for cleaning is received, a current time corresponds to a preset cleaning time set by a user, or the current time corresponds to an unused time which is determined based on a usage pattern of the cooking apparatus, the controller 200 may perform a determined cleaning process (hot air cleaning process or steam cleaning process).

The controller 200 may determine whether the user input for cleaning has been received through the user interface device 50 (3000).

The controller 200 may determine whether a cleaning time has been set by the user (3100).

In a case where the cleaning time has been set by the user (Yes in operation 3100), the controller 200 may determine whether the current time is the set cleaning time (3200).

Based on the current time being the set cleaning time (Yes in operation 3200), the controller 200 may perform the determined cleaning process.

Meanwhile, in a case where the cleaning time is not set by the user (No in operation 3100), the controller 200 may determine whether the current time is an unused time determined based on the usage pattern of the cooking apparatus (3400).

Based on the current time being the unused time determined based on the usage pattern of the cooking apparatus (Yes in operation 3400), the controller 200 may perform the determined cleaning process (hot air cleaning process or steam cleaning process) (3300).

According to the disclosure, rather than simply comparing images before and after cooking or being based on the accumulated number of times a cooking process is performed, by assigning a contamination weight to a location of image changes in real time and a contamination level, and accumulating the weights, an optimal cleaning process suitable for an actual contamination level may be determined and performed at an appropriate time, thereby automatically maintaining the inside of the cooking room in a clean state.

According to an embodiment of the disclosure, a cooking apparatus 1 may include: a cooking chamber 120 configured to accommodate an object to be cooked; a camera 60; and a controller 200 configured to cause the cooking apparatus to: obtain, by the camera, a plurality of images of an inside of the cooking chamber based on the object being accommodated in the cooking chamber and in a cooking process, compare the plurality of images to identify image change for each region, assign a contamination weight to the each region based on the image change, and perform a cleaning process based on completion of the cooking process and the contamination weight, wherein each image of the plurality of images includes a plurality of regions.

The controller 200 may be further configured to cause the cooking apparatus to: identify whether a region having the image change is a food region or a non-food region, wherein the contamination weight is greater for the region identified as the non-food region than for the region identified as the food region.

To assign the contamination weight may include to assign the contamination weight based on a changing value in pixel corresponding to the each region.

The controller 200 may be further configured to cause the cooking apparatus to: identify whether a region having the image change is a food region or a non-food region; wherein the contamination weight for the region identified as the food region is based on a distance between the region identified as the food region and a center of the object to be cooked.

The cleaning process may include at least one of a hot air cleaning process supplying heat to the inside of the cooking chamber, or a steam cleaning process supplying steam to the inside of the cooking chamber.

The controller 200 may be further configured to cause the cooking apparatus to: accumulate at least one contamination weight on each of at least one region among the plurality of regions for the each region, identify at least one contaminated region based on the accumulated contamination weight is greater than or equal to a predefined weight, sum the accumulated contamination weight of all of the at least one contaminated region, and perform the hot air cleaning process based on the summed contamination weight being greater than or equal to a preset first value.

To perform the cleaning process may include to perform the hot air cleaning process based on a number of times the cooking process is performed being greater than or equal to a preset number of times or, a one-time or accumulated cooking time being greater than or equal to a preset time.

The controller 200 may be further configured to cause the cooking apparatus to: sum at least one contamination weight on each of at least one region among the plurality of regions for the each region, or sum contamination weights on regions included in the at least one region, and perform the steam cleaning process based on the summed contamination weight being greater than or equal to a preset second value.

The controller 200 may be further configured to cause the cooking apparatus to: perform the hot air cleaning process prior to the steam cleaning process based on both a condition for the hot air cleaning process and a condition for the steam cleaning process being satisfied.

The controller 200 may be further configured to cause the cooking apparatus to: perform the cleaning process, based on at least one of receiving a user input for cleaning, a current time corresponding to a preset cleaning time set by a user, or a current time corresponding to an unused time identified based on a usage pattern of the cooking apparatus. According to an embodiment of the disclosure, a method for controlling a cooking apparatus 1 that includes a cooking chamber 120 configured to accommodate an object to be cooked, and a camera 60, the method may include: obtaining, by the camera, a plurality of images of an inside of a cooking chamber based on the object being accommodated in the cooking chamber and in a cooking process; comparing the plurality of images to identify image change for each region; assigning a contamination weight to the each region based on the image change; and performing a cleaning process based on completion of the cooking process and the contamination weight, wherein, each image of the plurality of images includes a plurality of regions.

The assigning of the contamination weight may further includes: identifying whether a region having the image change is a food region or a non-food region, wherein the contamination weight is greater for the region identified as the non-food region than for the region identified as the food region.

The assigning of the contamination weight may include assigning the contamination weight based on a changing value in pixel corresponding to the each region.

The assigning of the contamination weight may further includes: identifying whether a region having the image change is a food region or a non-food region; wherein the contamination weight for the region identified as the food region is based on a distance between the region identified as the food region and a center of the object to be cooked.

The cleaning process may include at least one of a hot air cleaning process supplying heat to the inside of the cooking chamber, or a steam cleaning process supplying steam to the inside of the cooking chamber.

The method may further includes: accumulating at least one contamination weight on each of at least one region among the plurality of regions for the each region; identifying at least one contaminated region based on the accumulated contamination weight is greater than or equal to a predefined weight; summing the accumulated contamination weight of all of the at least one contaminated region; and performing the hot air cleaning process based on the summed contamination weight being greater than or equal to a preset first value.

The performing the cleaning process may include performing the hot air cleaning process based on a number of times the cooking process is performed being greater than or equal to a preset number of times or, a one-time or accumulated cooking time being greater than or equal to a preset time.

The method may further includes: summing at least one contamination weight on each of at least one region among the plurality of regions for the each region, or summing contamination weights on regions included in the at least one region, and performing the steam cleaning process based on the summed contamination weight being greater than or equal to a preset second value.

The method may further includes: performing the hot air cleaning process prior to the steam cleaning process based on both a condition for the hot air cleaning process and a condition for the steam cleaning process being satisfied.

The method may further includes: performing the cleaning process, based on at least one of receiving a user input for cleaning, a current time corresponding to a preset cleaning time set by a user, or a current time corresponding to an unused time identified based on a usage pattern of the cooking apparatus.

Meanwhile, embodiments of the disclosure may be implemented in the form of a storage medium for storing instructions to be carried out by a computer. The instructions may be stored in the form of program codes, and when executed by a processor, may generate program modules to perform operation in the embodiments of the disclosure.

The computer-readable recording medium may include all kinds of recording media storing instructions that may be interpreted by a computer. For example, the computer-readable recording medium may be a read only memory (ROM), a random access memory (RAM), a magnetic tape, a magnetic disk, a flash memory, an optical data storage device, etc.

The computer-readable recording medium may be provided in the form of a non-transitory storage medium. Here, when a storage medium is referred to as “non-transitory,” it may be understood that the storage medium is tangible and does not include a signal (electromagnetic waves), but rather that data is semi-permanently or temporarily stored in the storage medium. For example, a “non-transitory storage medium” may include a buffer in which data is temporarily stored.

According to an embodiment of the disclosure, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloadable or uploadable) online via an application store (e.g., Play Store™) or between two user devices (e.g., smartphones) directly. When distributed online, at least part of the computer program product (e.g., a downloadable app) may be temporarily generated or at least temporarily stored in the machine-readable storage medium, such as a memory of the manufacturer's server, a server of the application store, or a relay server.

Although embodiments of the disclosure have been described with reference to the accompanying drawings, a person having ordinary skilled in the art will appreciate that other specific modifications may be easily made without departing from the technical spirit or essential features of the disclosure. Therefore, the foregoing embodiments should be regarded as illustrative rather than limiting in all aspects.

1. A cooking apparatus, comprising:
a cooking chamber configured to accommodate an object to be cooked;
a camera; and
a controller configured to cause the cooking apparatus to:
obtain, by the camera, a plurality of images of an inside of the cooking chamber based on the object being accommodated in the cooking chamber and in a cooking process,
compare the plurality of images to identify image change for each region,
assign a contamination weight to the each region based on the image change, and
perform a cleaning process based on completion of the cooking process and the contamination weight,
wherein each image of the plurality of images includes a plurality of regions.

2. The cooking apparatus of claim 1, wherein the controller is further configured to cause the cooking apparatus to:
identify whether a region having the image change is a food region or a non-food region,
wherein the contamination weight is greater for the region identified as the non-food region than for the region identified as the food region.

3. The cooking apparatus of claim 1, wherein to assign the contamination weight comprises to assign the contamination weight based on a changing value in pixel corresponding to the each region.

4. The cooking apparatus of claim 1, wherein the controller is further configured to cause the cooking apparatus to:
identify whether a region having the image change is a food region or a non-food region;
wherein the contamination weight for the region identified as the food region is based on a distance between the region identified as the food region and a center of the object to be cooked.

5. The cooking apparatus of claim 1, wherein
the cleaning process comprises at least one of a hot air cleaning process supplying heat to the inside of the cooking chamber, or a steam cleaning process supplying steam to the inside of the cooking chamber.

6. The cooking apparatus of claim 5, wherein
the controller is further configured to cause the cooking apparatus to:
accumulate at least one contamination weight on each of at least one region among the plurality of regions for the each region,
identify at least one contaminated region based on the accumulated contamination weight is greater than or equal to a predefined weight,
sum the accumulated contamination weight of all of the at least one contaminated region, and
perform the hot air cleaning process based on the summed contamination weight being greater than or equal to a preset first value.

7. The cooking apparatus of claim 5, wherein
to perform the cleaning process comprises to perform the hot air cleaning process based on a number of times the cooking process is performed being greater than or equal to a preset number of times or, a one-time or accumulated cooking time being greater than or equal to a preset time.

8. The cooking apparatus of claim 5, wherein
the controller is further configured to cause the cooking apparatus to:
sum at least one contamination weight on each of at least one region among the plurality of regions for the each region, or sum contamination weights on regions included in the at least one region, and
perform the steam cleaning process based on the summed contamination weight being greater than or equal to a preset second value.

9. The cooking apparatus of claim 5, wherein
the controller is further configured to cause the cooking apparatus to:
perform the hot air cleaning process prior to the steam cleaning process based on both a condition for the hot air cleaning process and a condition for the steam cleaning process being satisfied.

10. The cooking apparatus of claim 1, wherein the controller is further configured to cause the cooking apparatus to:
perform the cleaning process, based on at least one of receiving a user input for cleaning, a current time corresponding to a preset cleaning time set by a user, or a current time corresponding to an unused time identified based on a usage pattern of the cooking apparatus.

11. A method for controlling a cooking apparatus that includes a cooking chamber configured to accommodate an object to be cooked, and a camera, the method comprising:
obtaining, by the camera, a plurality of images of an inside of a cooking chamber based on the object being accommodated in the cooking chamber and in a cooking process;
comparing the plurality of images to identify image change for each region;
assigning a contamination weight to the each region based on the image change; and
performing a cleaning process based on completion of the cooking process and the contamination weight,
wherein, each image of the plurality of images includes a plurality of regions.

12. The method of claim 11, wherein the assigning of the contamination weight further includes:
identifying whether a region having the image change is a food region or a non-food region,
wherein the contamination weight is greater for the region identified as the non-food region than for the region identified as the food region.

13. The method of claim 11, wherein
the assigning of the contamination weight comprises assigning the contamination weight based on a changing value in pixel corresponding to the each region.

14. The method of claim 11, wherein the assigning of the contamination weight further includes:
identifying whether a region having the image change is a food region or a non-food region;
wherein the contamination weight for the region identified as the food region is based on a distance between the region identified as the food region and a center of the object to be cooked.

15. The method of claim 11, wherein
the cleaning process comprises at least one of a hot air cleaning process supplying heat to the inside of the cooking chamber, or a steam cleaning process supplying steam to the inside of the cooking chamber.

16. The method of claim 15, wherein the method further includes:
accumulating at least one contamination weight on each of at least one region among the plurality of regions for the each region;
identifying at least one contaminated region based on the accumulated contamination weight is greater than or equal to a predefined weight;
summing the accumulated contamination weight of all of the at least one contaminated region; and
performing the hot air cleaning process based on the summed contamination weight being greater than or equal to a preset first value.

17. The method of claim 15, wherein
the performing the cleaning process comprises performing the hot air cleaning process based on a number of times the cooking process is performed being greater than or equal to a preset number of times or, a one-time or accumulated cooking time being greater than or equal to a preset time.

18. The method of claim 15, wherein the method further includes:
summing at least one contamination weight on each of at least one region among the plurality of regions for the each region, or summing contamination weights on regions included in the at least one region, and
performing the steam cleaning process based on the summed contamination weight being greater than or equal to a preset second value.

19. The method of claim 15, wherein the method further includes:
performing the hot air cleaning process prior to the steam cleaning process based on both a condition for the hot air cleaning process and a condition for the steam cleaning process being satisfied.

20. The method of claim 11, wherein the method further includes:
performing the cleaning process, based on at least one of receiving a user input for cleaning, a current time corresponding to a preset cleaning time set by a user, or a current time corresponding to an unused time identified based on a usage pattern of the cooking apparatus.
